(19) United States
(12) Patent Application Publication
(10) Pub. No.: US 2011/0018278 A1
(43) Pub. Date: Jan. 27, 2011

(54) Device and method for capturing energy from building systems

(76) Inventor: John C. Tomaini, Warwick, NY (US)

Correspondence Address: Brian L. Wamsley, Esq., 119 Highview Avenue, Nanuet, NY, 10954, US

(21) Appl. No.: 12/804,547

(22) Filed: Jul. 24, 2010

Related U.S. Application Data
(60) Provisional application No. 61/271,701, filed on Jul. 24, 2009.

(51) Int. Cl. F03B 13/00

(52) U.S. Cl. 290/54

(57) ABSTRACT

A device or system for capturing kinetic energy from the flow of air, water or other fluid, from a building's heating, cooling, ventilation, air conditioning or water system. The device or system comprises placing a energy capturing device in the stream of air, water, or other fluid. The energy capturing device contains a bladed rotor, fan or turbine on a rotatable shaft connected to a power head, alternator or generator. The flow of air, water or other fluid turns the rotor or turbine, which activates the power head to generate line or low voltage electrical energy which is transmitted by wires for re-use, storage or sale to an electric company.

This application claims priority from U.S. provisional application No. 61/271,701 filed Jul. 24, 2009. The disclosure thereof is hereby incorporated herein by reference.

### BACKGROUND OF THE INVENTION

The present invention relates to a device, system and method for capturing the kinetic energy from a building's heating, air conditioning, ventilation and/or water system and converting that energy to electrical energy for re-use or storage. The devices can be installed in residential, commercial and industrial buildings wherever kinetic energy is created by the movement of air, water or other fluid caused by the building's heating or air conditioning systems, and becomes integral with those systems.

Nearly every home or commercial building creates energy that is lost or wasted. HVAC and ventilation systems create kinetic energy when air is flowing through air ducts throughout the building. Similarly, forced hot-air heating systems operate by the flow of hot air that has kinetic energy that is not utilized. Window air conditioners, external air-conditioning condensation units and cooling towers also create air flow and thus kinetic energy. Further, internal water systems in buildings create kinetic energy by the movement of water through the pipe system. Such kinetic energy is wasted in that it is not captured and converted to any form that can be reused.

Accordingly, there arises a need for a device or a system that is readily installable in a home or commercial system that captures the kinetic energy from air or water flow. The device needs to be energy efficient such that it is easily activated by the force of the air or water to drive a generator, alternator or power head to create line or low voltage. The device needs to be simple, easy to install, operate and maintain.

There is also a need for a device or system that converts the kinetic energy from air or water flow into electric energy that can be used, stored or sold to an electric company.

### SUMMARY OF THE INVENTION

A principle object of the present invention is to provide a device or system that is easily installed in a home or commercial system where kinetic energy is created by the flow or air, water or other fluid. It is also a principle object of the present invention to provide a device or system for capturing the kinetic energy created by the flow of air, water or other fluid and converting that kinetic energy to usable electrical energy.

The embodiments of the present invention are designed to be installed in the flowing air stream of an HVAC, heating or similar system of any size to capture the energy of the moving air with a fan, squirrel cage, air or rotor bladed turbine connected to a shaft connected to a generator to create line or low voltage. The line voltage is then re-introduced into a home or commercial power system in the same manner that a solar or wind power system is utilized. Thus, the kinetic energy of the flowing air is converted to mechanical and then to electrical energy that can be used or stored. Similarly, embodiments of the present invention are designed to capture the kinetic of the fluid side of a water system using a small turbine encased with an inlet and outlet so the fluid would spin the internal shaft attached to a generator—thus utilizing the flow of water, stream or fluid from a heating or domestic water system. The device would capture the energy created each time the water was run or the boiler was on or the steam came on and would return that energy via the line or low voltage generator back into the home energy system, in the same manner as a solar or wind system.

In accordance with the above objectives, a device and system for capturing the kinetic energy of flowing air, water or other fluid and converting that kinetic energy to electrical energy is provided. A device and system according to the embodiments of this invention comprises a frame or other support, usually constructed of non-corrodible light-weight metal, that supports an energy capture device such as a fan, squirrel cage, bladed rotor or turbine mounted on a rotatable shaft. The energy capture device can be aligned parallel to the flow of air or water, such that the flow of air or water engages the device on its side or edge, such as when a turbine or squirrel cage is used. Alternatively, when a fan or bladed rotor is used as the energy capture device, the device is aligned perpendicular to the flow of air, water or other fluid, so that the force of the fluid flow engages the device along the broader surface area of the blades, allowing more of the force of the fluid flow to be utilized, maximizing energy capture efficiency.

The frame may support one or more of the energy capture devices of the within invention. For example, when bladed rotor turbines are used, two or more of the turbines can be positioned along the length of the shaft. The number or turbines used is determined by the length of the shaft and the velocity of the air flow. Moreover, depending on the size dimensions of the system where the device is installed, more than one shaft containing turbines can be used, each shaft being connected to its own generator or power head.

When the energy capture device is intended for installation into a water or other liquid system, turbine type rotors are preferred. In addition, the frame in these applications comprise an enclosed structure or encasement for containing and directing the low of the liquid. In these embodiments, the turbine is necessarily aligned in the direction of the flow of the liquid.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a side view of an energy capture device system in a residential heating/cooling system in accordance with an embodiment of the present invention;

FIG. 2a is a top view of an energy capture device in accordance with an embodiment of the present invention;

FIG. 2b is a first side view of an energy capture device in accordance with an embodiment of the present invention;

FIG. 2b is second side view of an energy capture device in accordance with an embodiment of the present invention;

FIG. 3 is a side view of an energy capture device system in a water system in accordance with an embodiment of the present invention;

FIG. 4 is a front view of the embodiment of FIG. 3;

FIG. 5a is a side view of an energy capture device in accordance with an embodiment of the present invention;

FIG. 5b is a top view of an energy capture device in accordance with an embodiment of the present invention;

FIG. 6 is a top view of an embodiment of the present invention;

FIG. 7 is a perspective view of an embodiment of the present invention for a window air conditioning system;

FIG. 8 is a perspective view of an embodiment of the present invention for an external air conditioning condenser system; and

FIG. 9 is a side view of an embodiment of the present invention, installed in a roof-top cooling system.

### DETAILED DESCRIPTION OF THE PREFERRED EMBODIMENTS

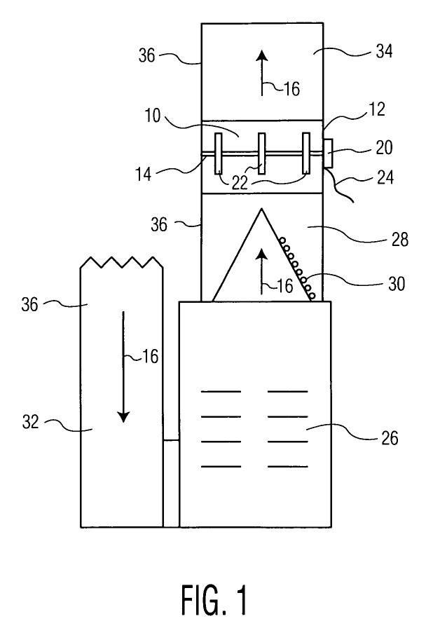

The preferred embodiments of the present invention will now be described with reference to the FIGS. 1-9 of the drawings. Identical elements in the various figures are designated with the same reference numerals.

An energy capture device 10 for converting kinetic energy into electrical energy, having features which make it particularly suited for residential or commercial building heating, cooling or water systems is described. The energy capture device generally includes a system for converting the flow of air, water or other fluid, into rotational mechanical motion and further converting the mechanical motion into electrical energy that can be utilized immediately, stored or transported using a conventional electrical wiring system. Accordingly, the energy capture device is installed in a building's heating/cooling system, or water supply. It will be understood how other energy capture devices may embody the principles and features of this invention.

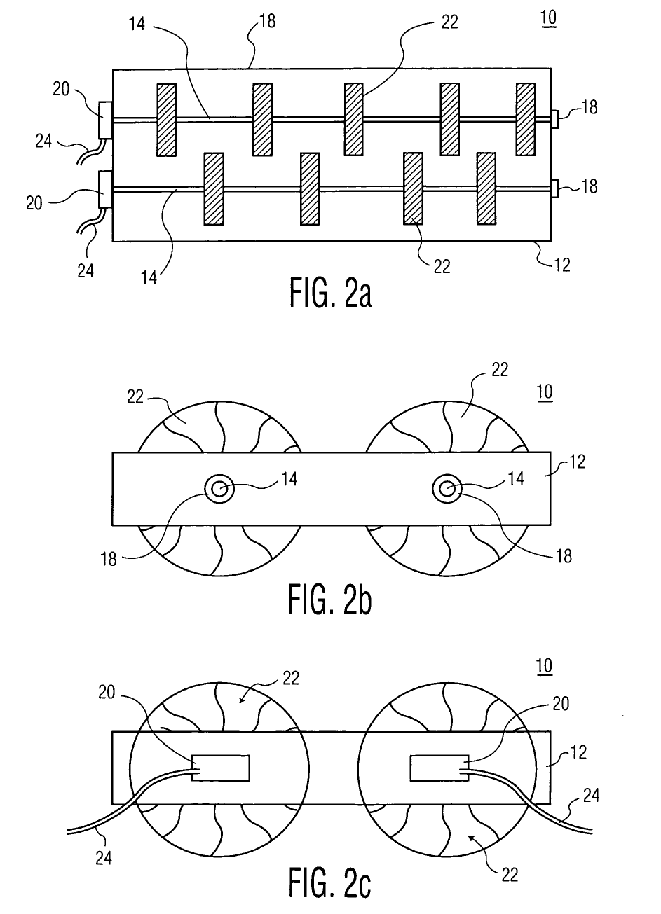

FIGS. 1-2a, b and c illustrate a first preferred embodiment of the energy capture device of the present invention, generally designated by the reference number 10. The energy capture device 10 comprises a frame 12, usually made of metal, through which a shaft 14 is positioned horizontally and perpendicular to the flow air. The shaft 14 is rotationally connected to low resistance bearings 18, which can be selected from those commercially available. A generator or power head 20 is located on at least one end of shaft 14 such that when shaft 14 is rotated, it operates the power head to generate low or line voltage energy.

Positioned along shaft 14 are fan blades or rotors 22, aligned perpendicularly to shaft 14 which makes them parallel to the flow of air. At least one rotor 22 is necessary although multiple rotors are preferred, the number depending on the length of the shaft 14 and the particular application of the energy capture device. The flow of air engages the rotors 22 causing them to and therefore shaft 14 spin. When shaft 14 is thus spinning, electrical low or line voltage energy is generated by power head 20, which is then channeled through wires 24, and made available to the electrical system of the residence or business, or can be stored in batteries or sold to the electric companies. The amount of electrical energy generated by power head depends on the speed in rpms of shaft 14, caused by the velocity of the air flow. Further, the power head 20 should be selected to provide high efficiency of conversion of mechanical to electrical energy as well as low resistance of operation of the power head. Thus, if the components of the energy capture device are properly selected, electricity can be generated for even the slightest amount of air flow velocity.

FIG. 1 illustrates a preferred embodiment of the energy capture device 10 installed in a typical residential heating/air conditioning system (“HVAC”). The HVAC system generally comprises an air handler or furnace 26 for heating, and an air conditioning unit 28 having cooling coils 30. Air is channeled the system by a duct system 36, which has an intake (or return) duct 32 as well as an outflow. Air flows in the intake 32, through the furnace 26 and across the coils 30 of the air conditioning unit, and out the outflow 34. The energy capture device 10 is installed, in this embodiment, above the air conditioning unit 28 and furnace 26, wherein shaft 14 is positioned horizontally to the direction of the flow of air such that the rotors 22 are aligned parallel to the air flow direction. In this orientation, the air flow 16 engages the rotors 22 from the edge of the rotors 22, thereby causing rotors 22 to turn and spin shaft 14 which generates low voltage electrical power in power head 20. This embodiment shows four rotors 22, although any practical number could be used, and usually depends on the length of shaft 14.

FIGS. 2a, b and c illustrate an embodiment of the energy capture device 10 itself, as could be employed in an air flow system as described herein or would be known to one of skill in the art. Energy device 10 comprises a frame 12 in which shafts 14 are mounted. Two shafts 14 are shown although any number of shafts 14 could be used depending on the dimensions of frame 12 as well as the air flow parameters of the system in which the device 10 is to be installed. For example, in larger systems or systems with higher velocity air flow, more shafts 14 could be used. Similarly, multiple rotors 22 are positioned perpendicularly along the shafts 14 to be engaged by the flow of air, the number of rotors 22 to be determined by the dimensions of the frame 12 and the velocity of the air flow. FIG. 2a is a top view of this embodiment while FIGS. 2b and 2c illustrate alternate side views. FIG. 2c shows one side of frame 12 on which multiple power heads 20 are positioned at the ends of shafts 14. Wires 24 extend from power heads 20 to transmit the electricity generated to its intended use. FIG. 2b shows the frame side opposite to that shown in FIG. 2c, on which there are bearings 18 at this end of shafts 14.

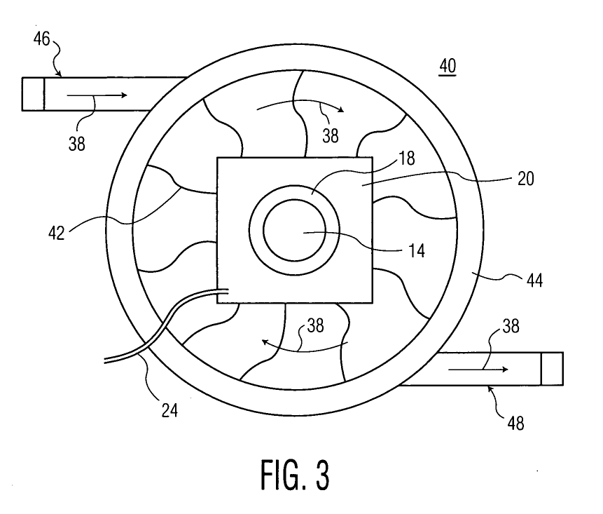

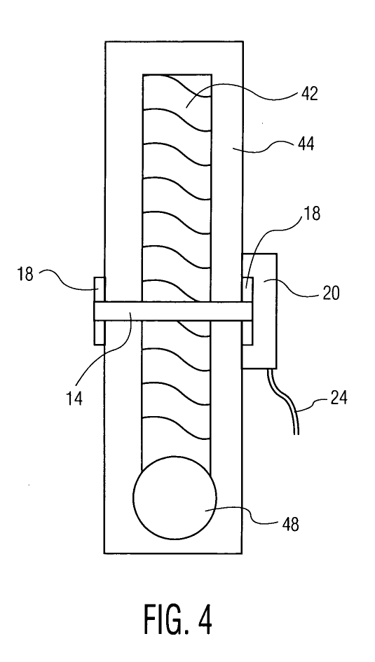

FIGS. 3 and 4 illustrate an embodiment of the energy capture device of the within invention in the form of a turbine 40 designed to capture energy from the flow of water or other liquid, with FIG. 3 being a side view and FIG. 4 being a front view. The turbine 40 comprises a circular encasement 44 that contains the flow of water. Encasement 44 contains an inlet 46 and an outlet 48 through which water flows in direction 38. Mounted within encasement 44 is a bladed turbine 42 which is mounted on shaft 14 perpendicularly to the flow of the water, so that the flow of the water causes the bladed turbine 42 to rotate. The speed of rotation of the bladed turbine 42 is governed by the water pressure at the inlet side 46 of the device. The shaft 14 is mounted on bearings 18 at each end of shaft 14. A power head 20 is connected at one end of shaft 14, such that the rotation of shaft 14 activates power head 20 and causes the conversion of the rotational energy of shaft 18 into electrical energy, which is collected through wires 24.

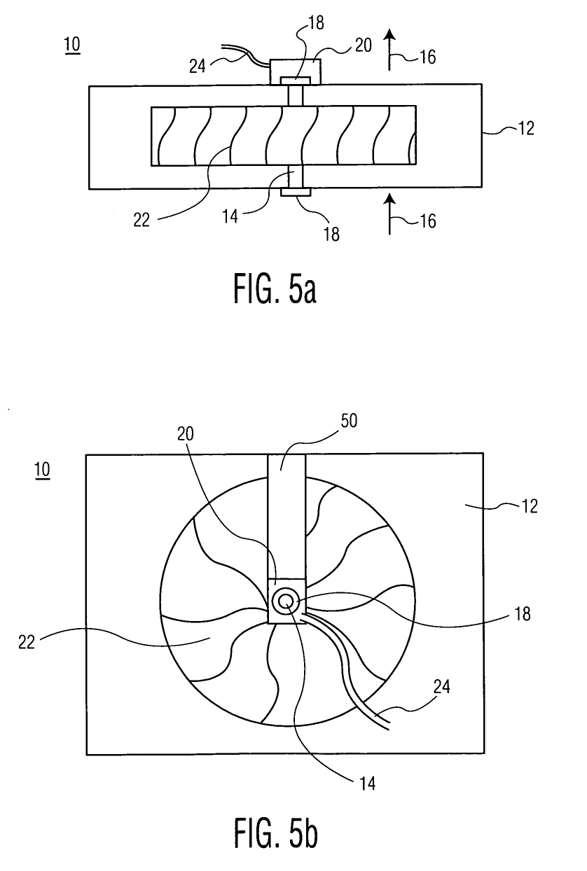

FIGS. 5a and 5b depict an embodiment of the energy capture device 10 of the within invention for installation into a flowing air stream in a horizontal or flat orientation with respect to the air flow such that the air flow engages the device along a much broader surface area. Similar to other embodiments described herein, the energy capture device 10 comprises a frame 12 and a shaft 14 on which is positioned a bladed rotor turbine 22 which, when contacted by the flowing air, causes the rotor turbine and the shaft to spin. The shaft 14 is held in place at the center of the frame 12 by a support arm 50 at each end of the shaft 14. Each support arm 50 contains a bearing 18 into which each end of the shaft 14 is inserted, allowing for free rotation of the shaft. A power head 20 is also positioned on at least one end of the shaft 14. When shaft 14 is spun by the airflow, the power head 20 is activated and low voltage electrical energy is generated.

As depicted in FIG. 5a, a side view of this embodiment, the energy capture device 10 is positioned perpendicularly to the direction of the flow of air 16. One advantage of this embodiment is that larger turbine or fan blades may be used than in other embodiments. Thus, in this position, the airflow is directed to the broader surface of the rotor turbine blades thereby providing a maximum efficiency of the kinetic force of the airflow to spin the turbine. As in other embodiments, the amount of electrical energy generated is determined by the velocity of the airflow and therefore the speed of the turbine.

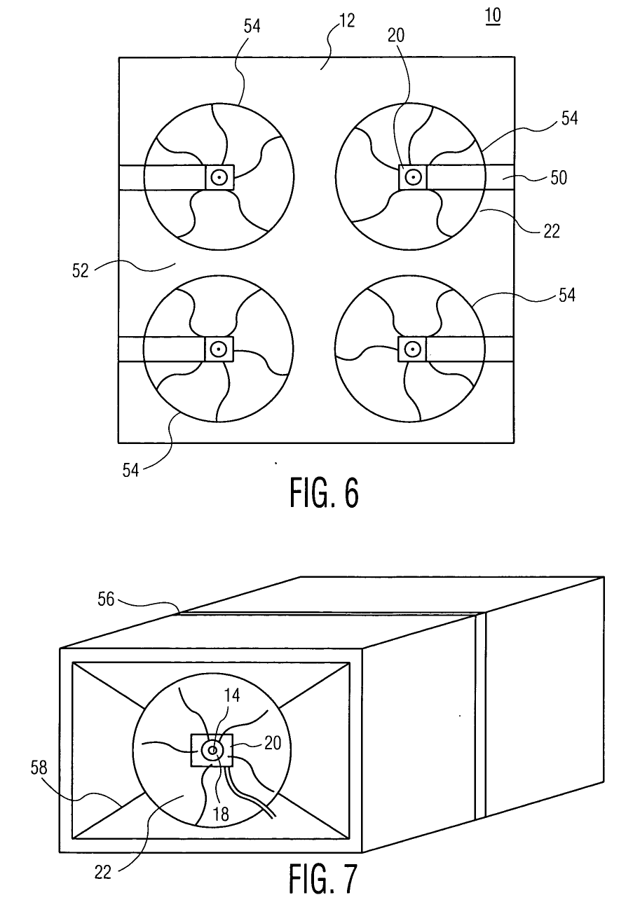

For larger airshafts such as may be found in commercial buildings or warehouses, multiple units of the energy capture device of FIGS. 5a and 5b may be combined in a single frame 12 (FIG. 6). This solves the problem of not having to manufacture a single large rotor turbine, that may to too expensive or cumbersome to operate as efficiently than a smaller unit. A further advantage is that multiple power heads 20 would be used, thus increasing the amount of electrical energy generated over the use of a single turbine with a power head. When multiple energy capture units are used in this manner, the frame 12 is not an entirely open structure, but generally comprises a solid piece 52, usually metal, containing openings 54 for the rotor turbines 22. In this manner, the air flow is directed to the turbines 22 and is not lost in open spaces between them.

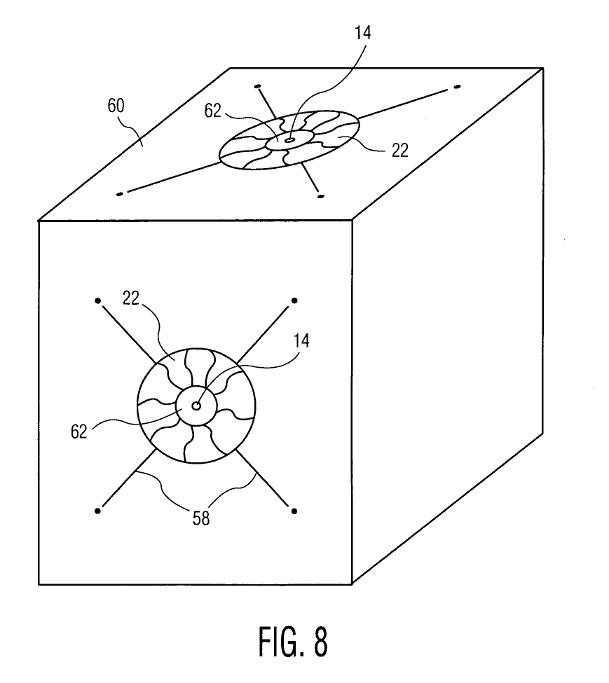

FIG. 7 depicts an embodiment of the energy capture device 10 of the within invention installed in a window air conditioning unit such as is found in many residences and offices. In this embodiment, a bladed rotor turbine 22 is positioned at the exhaust end of the air conditioner housing 56, and can be held in place by supports 58 or other similar means. The rotor turbine 22 is of the same design and construction as depicted in FIGS. 5a and 5b. Similarly, the energy capture device of this invention can be mounted on the housing 60 of an outside air conditioner condenser unit, as seen in FIG. 8. In this embodiment, a rotor turbine may be used or an alternator/generator 62 can be attached to the exhaust fan of the a/c unit housing 60, wherever there is the best velocity of airflow.

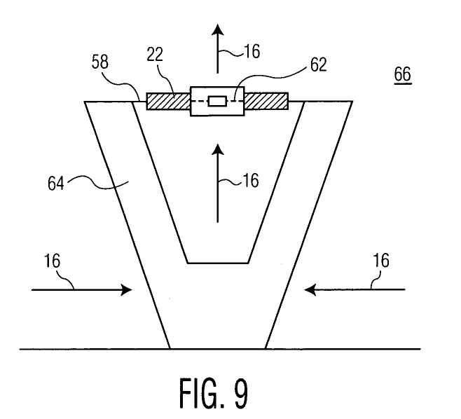

FIG. 9 illustrates an embodiment of the invention mounted at the top, or exhaust, of a rooftop chiller or cooling tower. 66. The cooling tower 66 contains chiller coils 64 arranged generally in a “V” formation, with air flow 16 coming in from the sides and exiting through an opening at the top of the coils 64. The energy capture device of this embodiment can be in the form of the rotor turbine of FIGS. 5a and 5b, mounted by supports 58 in the space at the top of the coils 64, causing the exhaust air to spin the rotor turbine 22, which is connected to the alternator/generator device 62 to generate electricity.

The preceding preferred embodiments are illustrative of the practice of the invention. It is to be understood, however, that other expedients known to those of skill in the art, or disclosed herein, may be employed without departing from the spirit of the invention or the scope of the claims.

What is claimed is:

1. A system for capturing the kinetic energy created from the flow of air, water or other liquid in a building comprising: in a building, means for creating a positive flow of air, water or other fluid, an energy capture device placed at the discharge or downstream side of the air, water or other fluid flow stream, said energy capture device comprising; a frame member, a rotatable member disposed within said frame member and configured to be in contact with said flow of air or water, said rotatable member being mounted on a rotatable shaft and at least one electricity generating device disposed at at least one end of said shaft, wherein said flow of air, water or other fluid causes the rotatable member and the shaft to spin whereby the electricity generating device is activated to generate electricity.

2. The system according to claim 1 wherein the rotatable member is held in place within the frame by supports.

3. The system according to claim 1 wherein the rotatable member comprises a fan, a squirrel cage, a bladed rotor or a turbine.

4. The system according to claim 3 wherein more than one energy capture device is disposed in said frame member.

5. The system according to claim 1 wherein the fluid is air and the rotatable member is a fan, bladed rotor, squirrel cage or turbine.

6. The system according to claim 5 wherein said rotatable member has a side or edge portion and is disposed in the direction of the flow of air, and the air flow contacts the rotatable member at its side or edge.

7. The system according to claim 5 wherein said rotatable member is disposed perpendicularly to the direction of the flow of air.

8. The system according to claim 1 wherein said electricity generating device is a powerhead, generator or alternator.

9. The system according to claim 1 wherein said fluid is water and said housing is enclosed to contain said water.

10. The system according to claim 9 wherein said rotatable member has a side or edge portion and is disposed in the direction of the flow of water, and the water flow contacts the rotatable member at its side or edge.

11. A method for capturing the kinetic energy created from the flow of air, water or other liquid in a building comprising the steps of: installing, in a building having means for creating a positive flow of air, water or other fluid, an energy capture device at the discharge or downstream side of the air, water or other fluid flow stream, said energy capture device comprising; a frame member, a rotatable member disposed within said frame member and configured to be in contact with said flow of air or water, said rotatable member being mounted on a rotatable shaft and at least one electricity generating device disposed at at least one end of said shaft; directing the flow of air, water or other fluid to contact the rotatable member and therefore to spin the shaft, generating electrical current by a generating device, and directing said electrical current to be stored, re-used within said building or to be transported outside of said building.

12. The method according to claim 11 wherein the rotatable member is held in place within the frame by supports.

13. The method according to claim 11 wherein the rotatable member comprises a fan, a squirrel cage, a bladed rotor or a turbine.

14. The method according to claim 13 wherein more than one energy capture device is disposed in said frame member.

15. The method according to claim 11 wherein the fluid is air and the rotatable member is a fan, bladed rotor, squirrel cage or turbine.

16. The method according to claim 15 wherein said rotatable member has a side or edge portion and is disposed in the direction of the flow of air, and the air flow contacts the rotatable member at its side or edge.

17. The method according to claim 15 wherein said rotatable member is disposed perpendicularly to the direction of the flow of air.

18. The method according to claim 11 wherein said electricity generating device is a powerhead, generator or alternator.

19. The method according to claim 11 wherein said fluid is water and said housing is enclosed to contain said water.

20. The method according to claim 19 wherein said rotatable member has a side or edge portion and is disposed in the direction of the flow of water, and the water flow contacts the rotatable member at its side or edge.
